(19) United States
(12) Patent Application Publication
(10) Pub. No.: US 2002/0138625 A1
(43) Pub. Date: Sep. 26, 2002

(54) Method and apparatus for inflight electronic commerce

(76) Inventors: David Bruner, Sammamish, WA (US); Yan Shvalb, Boca Raton, FL (US); Mordecai Zibkoff, Ft. Lauderdale, FL (US)

Correspondence Address: BUCHANAN INGERSOLL, P.C., ONE OXFORD CENTRE, 301 GRANT STREET, 20TH FLOOR, PITTSBURGH, PA, 15219, US

(21) Appl. No.: 09/814,492

(22) Filed: Mar. 21, 2001

(51) Int. Cl. G06F 15/16

(52) U.S. Cl. 709/227; 709/249

(57) ABSTRACT

Method and apparatus for remote users to access the world wide web without requiring large bandwidth connections. The system is intended mainly for use by traveling users. The mobile users are connected to a remote server which is in wireless communication with a central, land-based server. The central server communicates with a telecommunication network, such as the internet. The remote server communicates with the central server to periodically update the website information on the remote server. The mobile remote user is connected directly to the remote server, and thus indirectly to the internet. Hence the user's connection with the remote server gives him or her the look and feel of a direct website connection. Because the remote server periodically receives updated website information from the central server, which may be limited to partner websites as well, the bandwidth required for the transmittal of such information is minimized.

### BACKGROUND OF THE INVENTION

1. Technical Field

The present invention is directed to a method and apparatus for providing electronic on-line commerce, and more particularly to a airline-based system for providing electronic commerce to passengers during flights. While the invention is described with specific reference to an in-flight intranet system, it will be understood by those skilled the art that the invention is generally applicable to any remote vehicle or building including aircraft, ships, trains and hotels.

2. Description of the Prior Art

The increasing use of the Internet and the World Wide Web as an electronic information source and means for purchase of goods and services is becoming more and more common. Users of the web can access information and merchant sites at any location, such as the home and office. Moreover, laptop computers and handheld palm computers give individuals increased mobility allowing access to the Internet almost anywhere. A significant limitation to this access to the Internet occurs while users are in transit from one location to another, and more particularly during airline flights.

One of the main reasons for this is that it is difficult to provide a phone connection from a moving aircraft to ground base website servers for connection from a personal portable computer. For example, use of cellular phones on aircraft is prohibited under Federal Aviation Regulations due to possible interference with airline communication systems. Thus, while a ground-based cellular phone user with a laptop computer can access the Internet so as to retrieve e-mail and other information, this is currently not practical onboard flying aircraft. While most major airlines provide for access to some limited information during airline flights, this is generally limited to the proprietary systems offered by the individual airlines. For example, calls may be made from flying aircraft to ground based telephone systems, and certain limited information may be made available through these telephone handsets which are generally located in the seatback of a passengers seat. Information, such as being able to fax a document or send an e-mail to a ground based recipient or obtain stock quotes can be accessed, but browsing the Internet or the World Wide Web is not available through these limited access handsets. While a user may gain access to the internet through prior art systems, such connections are limited due to the cost, bandwidth restrictions, response time when accessing websites and reliability This results in limited usefulness with conventional systems, since complete internet service is not feasible due to these restrictions.

It currently is not practical to access the internet or world wide web from a mobile location, such as an aircraft or cruise ship, due to bandwidth restrictions. Typically, a webpage requires about 50 k to 60 k bytes of information. The bandwidth required to keep these webpages constantly updated can easily exceed the resources available to transmit this vast amount of information. This is also true of remote land based users such as those located in rural areas or on a floating oil rig, for example. The communication pathways currently available for such remote users are not practical for continuously transmitting large amounts of information. While large bandwidth systems are available, the cost for these make them impractical for use by a small number of users.

It would be advantageous if remote internet users, such as in-flight passengers, during the course of an airline flight could access the internet so as to either keep abreast of current information or have access to Internet e-mail accounts for performing productive work. It would also be advantageous if airline passengers could browse the Internet as is commonly done now in ground-based systems for purchase of products or services on the World Wide Web.

It is therefore an object of the present invention to provide a method and apparatus to allow airline passengers or other remotely located users, to access the Internet during the course of an airline flight, or from remote land-based locations.

It is a further object of the present invention to allow such passengers to engage in electronic commerce from the comfort of their airline seat.

It is still further object of the present invention to provide a system whereby passengers in different seats and on different sections of the airplane can conduct electronic conversations without having to relocate their seats.

### SUMMARY OF THE INVENTION

The above objects are attained by the present invention, according to which, briefly stated, a system is provided to allow remotely located Internet users, such as airline passengers, to conduct electronic commerce from the remotes location, for example, from their seats during the course of an airline flight. The present invention is directed to an environment where communications with the world wide web are bandwidth limited, expensive or intermittent. The invention provides for extraction of data from the web and distribution of a subset of the data to remote servers, which are then kept in synchronization with the web via communications software. Thus the present invention utilizes intelligent caching and communication to provide effective internet access to remote users. In a presently preferred embodiment, the system comprises a remote server computer located within the aircraft to control the operations of the system for the passengers in their seats at terminals or phone connections mounted in their seat location. The remote aircraft server is in effective communication with a land-based central server computer for the exchange of information between the central land-based and the remote in-flight aircraft. The connection is provided to the remote intranet system of the present invention to allow airline passengers to browse through information or purchase produces much in the same manner as they do with their ground-based home or office computer.

The manner in which a passenger accesses the remote server can be of various means. Such connection may be accomplished via an installed telephone network as set forth above. Alternatively, the service may be installed on an aircraft's inflight entertainment network which provides a user screen and input device not connected via telephone lines. In either type of connection, the present invention facilitates loading of data to the remote server, updating with new data and real-time processing of transactions as normally occurs with a conventional land-based internet connection.

The invention comprises a system for remote users to access a telecommunications network, the system having a fixed server operably connected to the telecommunications network and a remote server, includes the remote server connection means for a remote user to access the remote server, and a communication link for connecting the remote server to the fixed server whereby the remote user is connected to the telecommunications network.

In a method of connecting remote internet users with a central telecommunications network, the said method comprises the steps of providing a remote internet server including means for connecting a remote internet user with the remote internet server, providing a ground based internet server for connection to the central telecommunications network and connecting the mobile internet server with said ground based internet server.

The system of the present invention operate is an Internet Content Provider and software developer that makes access to e-mail, real-time Internet and entertainment content affordable and reliable to remote travelers in commercial airplanes, business jets and cruise ships where access to these services is expensive, difficult or unavailable. The present invention delivers high-speed connections and uses a combination of existing satellite systems and ground technologies to update information on the onboard server. The re-hosting technology of the present invention supports dynamic updates, enabling real time news, financial and sports information, and enables real-time e-commerce from the remote location, while managing expensive off-aircraft bandwidth. The service masks the connection to the ground by accelerating server response onboard the moving vehicle, and providing state-of-the-art compression, message handling, and proprietary data management requiring very few bytes to be transmitted to complete a transaction. User can typically enjoy a reliable 56 Kbps to 2 Mbps connection to the onboard server, depending on servers and in-flight entertainment systems available on the aircraft or ship.

Thus, the system of the present invention provides web based e-commerce, information and entertainment to remote users, such as onboard flight passengers.

### BRIEF DESCRIPTION OF THE DRAWINGS

Various other objects, features some advantages of the invention will become more apparent by reading the following detailed description in conjunction with the drawings, which are shown by way of example only, wherein:

FIG. 1 shows a schematic diagram of the hardware used to operate the system according to the present invention;

FIG. 2 shows a homepage initial site map for airline passengers logging into the inflight Internet system; and

FIG. 3 shows a typical menu for a premium electronic commerce system provided to inflight airline passengers according to the present invention.

### DESCRIPTION OF THE PREFERRED EMBODIMENT

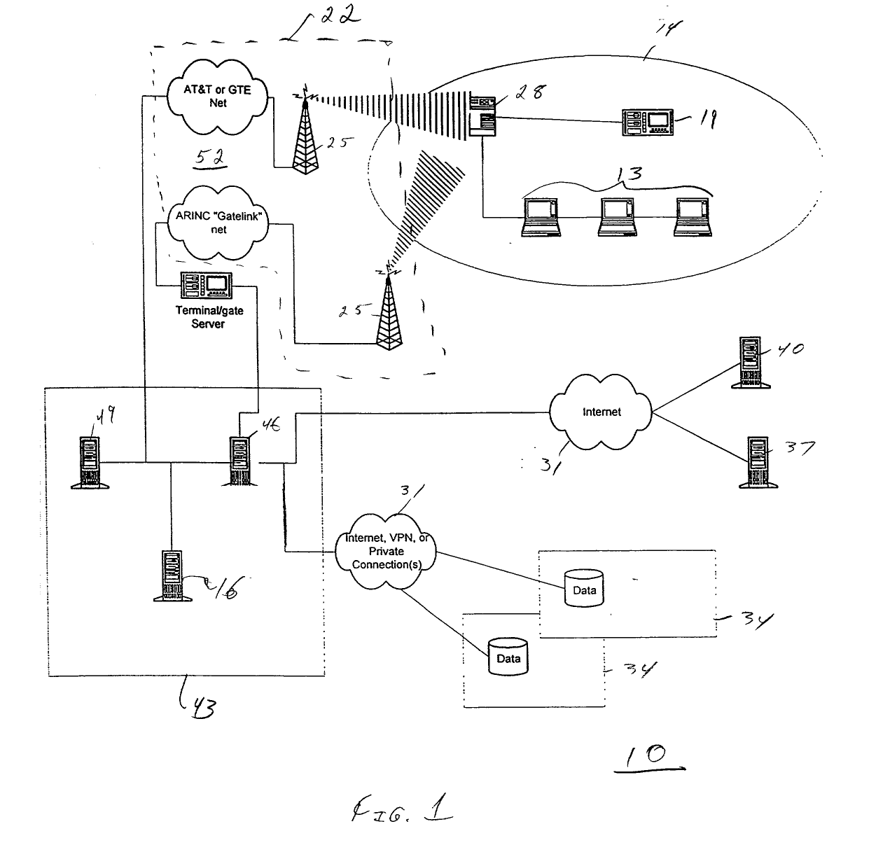

Referring now to the drawings in detail, there is shown in FIG. 1 a schematic diagram of the hardware for operating the remote internet system 10 of the present invention to allow remote users 13, such as airline passengers, to conduct electronic commerce (“e-commerce”) from a remote location 14, such as during the course of an airline flight. The system topology as shown in FIG. 1 comprises a central website server 16 which preferably supports all ground based visitors traffic and transactions, as well as supporting the routing, tracking and management of traffic and transactions routed from the remote airborne users 13. The airborne users 13 are connected to the system via the aircraft based user terminals which are connected to an airline-based remote server computer 19. By using a communications network 22, such as provided by ground-based radio towers 25 and/or satellite based remote communication systems, the airborne based remote equipment 19 communicates with the network on the ground based central system 16. The remote system preferably includes remote communication equipment 28 operably connected with the communication network 22. Also the ground based systems are interconnected with website containing data 31 which are preferably operated by partners 34 with the system 10 of the present invention. The system also has access to non-partner websites 37 to allow the airborne based user 13 to access information from other websites, or to browse the users e-mail server 40 so as to provide communication between the remote traveler 13 and his or her home system 40 via the internet.

Thus, the system of the present invention allows airline passengers to scan the Internet, including accessing informational resources, viewing entertainment, shopping on-line through electronic commerce, purchasing products and accessing e-mail while in flight.

The systems 10 topology is divided into three separate but interconnected components: the Ground Server Network (GSN) 43, the central home web server site 16; and the Airborne Data Server (ADS). The ADS is the inflight remote server 19 that preferably serves content to inflight users of the system and also acts as a gateway to the ground based servers (16, 34, 37, 40) for additional content. From a laptop computer for example, an inflight passenger 13 initiates a dial-up networking PPP connection to the ADS server 19 via the inflight telephone connection (not shown) located adjacent the passenger 13, such as in the seatback or in the armrest of the airline passengers seat. The ADS server 19 operates a host of software components including an HTTP server, DHP server, DNS server, database server, mail server and preferably chat and streaming servers. After the PPP connection is established, the ADS server 19 will provide an IP address, DNS server address and any default gateway information to the user 13. From this point, the user utilizes his or her internet browser software running on the laptop to access a variety of content. In an alternative embodiment, a screen and keyboard can be provided at the passengers seat for the user 13 connection, eliminating the need for the user to have his or her laptop computer. The web application will validate the user, and provide him or her additional content and offer commerce functionality. Preferably all data required for support of the application is stored within the database server 49, and security restrictions are in place to verify that only those persons with appropriate rights can view the data and access system functionality.

The GSN 43 preferably comprises a set of distributed servers 46, in addition to the central server 16, that are responsible for the deployment of content, synchronization of data to and from the ADS, and to enhance communications performance. The central site network 43 supports all ground based visitor traffic and transactions, as well as supporting the routing, tracking, and management of traffic and transactions routed from airborne users. These servers are preferably load balanced for optimal performance. All data required for support of applications is stored within the database server 49, and security restrictions are in place to verify that only those persons with appropriate rights can see the data. Preferably, profile and registration information for users 13 are stored on the database server 49. Although multiple servers are shown for each function, it will be apparent to those skilled in the art that these functions can be shared by a one or more servers.

With the system 10 of the present invention, airborne users do not communicate directly with the ground network 43 but use the remote ADS server 19 as a router. Instead, all services are provided via a proxy or gateway services. Therefore network address translation is not necessary for security purposes. Alternatively the inflight airborne server is connected to existing proprietary telecommunications networks 52, such as operated by GTE, AT&T, or INMARSAT resellers like COMSAT. For this reason, firewalling or filtering of content is provided. Altering of connections can be configured to allow only communication to and from the ground distribution servers 46 and the central site 14. This provides protection from any unwanted traffic on the telecommunications network 22, as well as preventing users from bypassing the log-in and accounting services involved with the ADS or gateway.

Access to ground based internet content, whether e-commerce or e-mail, is preferably via an application layered gateway or proxy, present on the airborne server 19. Such a system provides that the proxy services insure that all air to ground traffic may be logged and billed accordingly. Such a system also permits prioritization and queuing to be applied to the data flow. The web proxy also allows for additional cache data retrieval, conserving bandwidth. An example of such an open source proxy is Squid Version 2.2.4 which provides HTTP, FTP, and Gopher proxying and caching.

The Systems' GSN 43 detects changes on the ground sites that need to be synchronized with the aircraft or ship to provide the most up-to-date information. In addition to determining the best method to update the ship or airborne server, the ground center performs the following functions: a) Supports routing, tracking and management of traffic and transactions from airborne or at sea users; b) Supplies billing functionality, including real time credit card processing for inflight transactions; c) Manages and stores user profiles, enabling metrics, personalized web experiences and redundancy; d) Stores data for all applications and ensures regular synchronization with partner content sites to provide the most up-to-date information; and e) Provide security to verify that only those persons with appropriate rights can see the data.

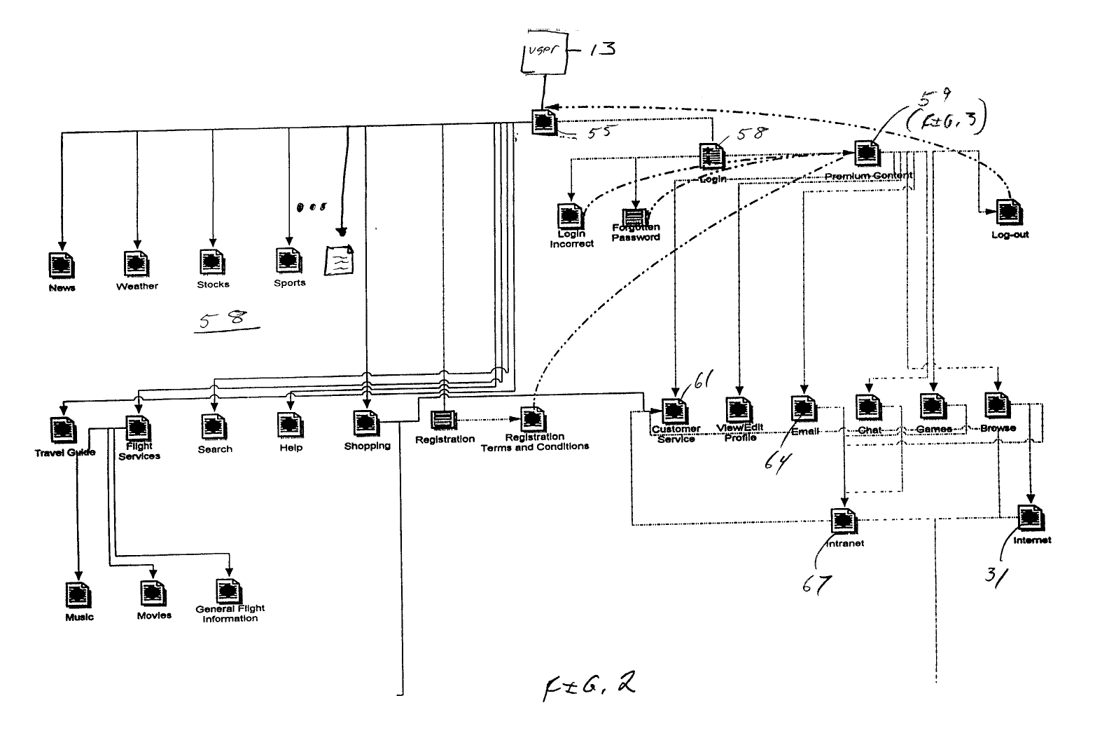

Preferably, as shown in FIG. 2, the user 10 upon accessing the system of the present invention via a home page 55 logs in 58 by providing a user name and password. The username and password can be provided when the user first accesses the system and provides necessary registration information to be able to use all the functions of the airborne based internet service of the present invention. Such a registration system is well known to those skilled in the art in providing internet based commerce systems.

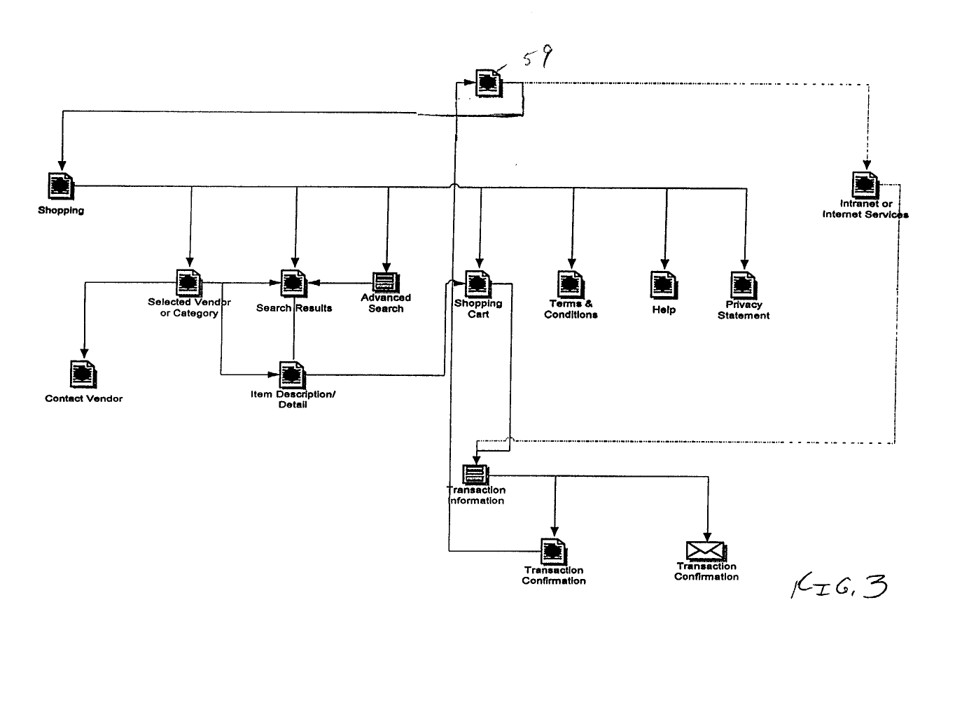

By way of brief example, the user provides basic information, such as name, e-mail address, and any other personal information that the operator of the site wishes to capture for future reference. For example, it may be desired to know certain demographic data about the user, such as age, sex, and home location, in order to be able to provide designated information to users who fit profiles of generally recognized demographic information. This user profile information is then stored on the database server 49. Thus the next time the user accesses the site, that user inputs the log-in information and is then given access to the full content of the system 10. Further, by way of example, there is shown in FIG. 2 numerous different sites 58 that the user can access. Information such as news, weather, stocks and sports, as well as access to travel guide, or flight services that can be provided during the course of the flight such as music, movies, and general flight information such as location of the aircraft, airspeed and estimated time to destination. In addition to information content, the user also has access to traditional e-commerce sites such as search engines and on-line shopping. These premium services 59 are shown in more detail in FIG. 3. In addition to the traditional e-commerce activities of information and product purchasing, the user can also access a customer service area 61 of the remote inflight internet system so as to perform routine functions such as viewing and editing the users profile and getting general help from the operator of the inflight service.

In addition, the user can gain access to his or her land based e-mail system 64 and or an aircraft's intranet 67, which is a system accessible only by those members on the flight or, more generally, those connected to the remote server 19, wherever it may be located. Within the intranet, users may be engaged in conversations or chat with other passengers on the flight, engage in on-flight activities such as games or browsing through activities provided on the ADS server. The intranet also provides access to the internet through the ground based GSN 43.

As shown in FIG. 3, the inflight premium service 59 gives the remote user 13 access to additional e-commerce activities. The user 13 can have access to designated vendors who are partners with the inflight service operator so that a user can select single vendors of products or a specific category of products offered by more than one vendor, so as to view items descriptions in detail after conducting a search to make choices of products or services to purchase. Preferably, an on-line shopping cart system is provided whereby those selected products are provided in a separate area so that the user can periodically review the selected items and total purchase price for those items. Additionally, the terms and conditions under which products are purchased and general information such as help screens and the services privacy statement can be provided for viewing by the user. The remote user 13 can then initiate a transaction for the purchase of the products listed in the shopping cart and transaction confirmation can be provided back to the user after the transaction is processed, according to mechanisms well known to those skilled in the art for the on-line purchase of products and services.

By providing a user profile through the registration process, the user can input information which becomes preexisting validated account information such that the user has prior credit approval, personal shopping information and can also input important date reminders so that the user can be notified at any time of appointments and meetings that may be scheduled while performing normal functions such as retrieving e-mail. In addition, the user can be updated with current shipping status on recent purchases, the data from which can be gathered to provide more personalization of the product and service choices directed to the users. The user can be given e-mail notification of purchase confirmations, shipment dates and alerts to new products of offerings which may be of interest to the user based on their profile. News and other information can be provided to the user, such as information regarding the airline frequent flyer information, certain car rental promotions and even information regarding the additional segments of the user's trips, such as connecting information for the next flight that the user may be taking.

General information is provided such as the weather information at the flights destination. The user is provided with a menu of purchase options that maybe provided by partners to the system such as car rental services, jewelry, flowers and other information and product services such as Hoovers on line, Fidelity Investments, Lands End and Royal Caribbean Cruises. Information is provided in another menu through traditional informational sources such as National Geographic, Business Week, Ticket Master online, IVillage, etc. Preferably an area is also provided for breaking news articles such as provided under a top news category.

The following chart describes the interfaces to the system for its external participants, as well as the interfaces of the various subsystems to each other.

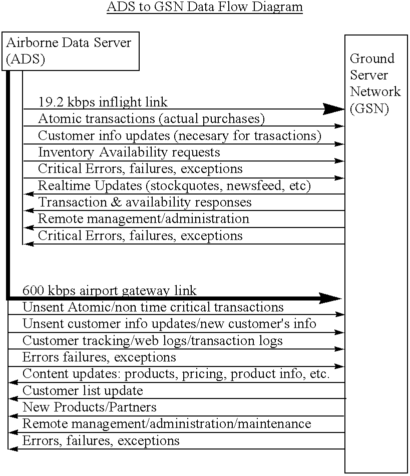

The above flow chart shows the types of data-flow that will occur between the ADS 19 and the ground server network 43. It shows the appropriate use of each of the different types of network links. Preferably, the 19.2 kbps in-flight link is available with a data server provided by AT&T, which server is well known in the art. It is a link made of 2, bonded 9.6 kbps links. Most preferably, this relatively low bandwidth in-flight link is complemented by a high bandwidth (600 kbps) one way satellite up link to the aircraft. However, the system is not dependent on currently unavailable technology. Other wireless communication systems can be used as the communication link 22 between the remote server 19 and the central server 16.

The following flow chart describes the types of data-flow that will occur between the Ground Server Network (GSN) and the system partner's e-commerce systems and web sites.

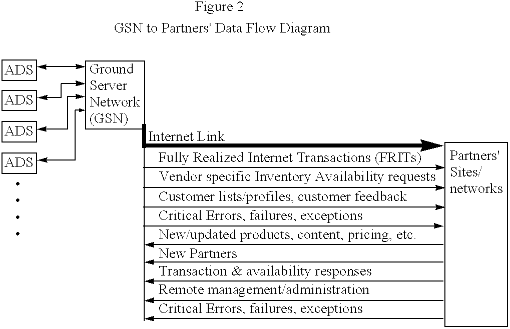

GSN-Parters' Sites Messages

Fully realized internet transactions (FRITS)—these messages are the result of taking an atomic transaction, replacing the ID's with the data in the corresponding record, and formatting the data into an http request or series of requests that the partner's existing e-commerce site can process. It should be as if a real e-customer were accessing the partner's web site via a web browser. This process will be referred to as transaction transformation. Each transformation is partner specific. Therefore, it would make sense if there were a way of assembling the relevant data necessary for a fully realized internet transaction, and passing that generic FRIT to a transformation engine, which would in turn use some sort of transformation script to create and execute the FRIT. The transformation modules or scripts would either be created by us, or by our partners.

Vendor Specific inventory requests—These correspond to inventory availability requests. They would also be a form of FRIT.

Customer lists/profiles, customer feedback—the customer lists and profiles would be sent to certain partners for a fee, after being processed to remove sensitive info such as specific payment info, and any info that the customer objects to being published/sold. Statistical information concerning interaction with the partners content cold also be sent. Customer feedback is basically e-mail/messaging that we would collect and pass on to the appropriate partner.

Errors, Failures, Exceptions

Partners' Sites—GSN Messages

New Partners, New/Updated Products, Pricing, etc.—These messages correspond to the GSN—ADS updates, which are preferably implemented by having the system point at a URL in the partners' network, which would be synchronized into the in-flight system of the present invention. More likely an administration system is to be set up for partner interaction and content updating.

Transaction & availability responses—These messages correspond to the GSN—ADS updates which are to be passed seamlessly to the proper ADS that originated the corresponding request.

Remote Management/administration—These are messages to modify, update, change content, request statistics, or customer profiles.

Errors, Failures, Exceptions

Functional Requirements

The proposed system preferably provides the following:

Electronic Catalog

The ability to store, search and display all products from all vendors/partners in a manner and appearance that is similar if not identical to the way that such products are displayed on the partners/vendors original web site, within the in-flight passenger's web browser.

Customer Profile

The ability to display a form for collecting required information for purchasing goods and services from senders.

The ability to store this customer specific information into a profile for later use.

The ability for the customer to change this data through another online form.

The system should use this information when submitting a request for purchase to one of our partners.

Credit Card Verification/Secure Data Transfer

The ability to receive a form of electronic payment (credit cards, charge cards, debit cards, electronic cash) in order for a purchase to occur.

The ability to either process a payment for a partner, or pass relevant payment information securely to the partner's web site as part of a fully realized Internet transaction as defined earlier.

Shopping Cart/On Screen Invoicing

The ability to maintain shopping carts for each customer/passenger, where references to possible purchases would be stored.

Display of the shopping cart should be in the form of a table. Multiple items from the same vendor should be grouped under a subhead that contains the vendor's name and logo. Each row beneath that heading should contain a quantity, a product SKU# (or other unique product ID), the product name, a brief description of the product, a per-unit price, and a total amount. The product description should contain no more than 2-3 short words, but might also contain such things as reservation date for a car/hotel room/restaurant reservation where applicable. The bottom of the page should calculate totals.

The Display preferably allow removal of shopping cart items, as well as changing of things such as quantity, and a button for recalculating totals.

There should be a button or other interface element for submitting the order for checkout. This would take the transactions that are sitting in the shopping cart and put them into the queue for transmission. After this occurs, another page will appear that will contain a message confirming receipt of the order for processing.

Another message containing all of the info that the shopping-cart page contained, as well as all of the shipping and billing info, should be composed, and left inside the customer's message area. This process would occur in the background.

Transaction Queuing, Processing and Sending.

After an order gets submitted for processing (through mechanisms in step 5.5), an “order process” assembles all of the quantity, product identification and Price identification lines for a particular transaction together. It then adds the transaction ID and customer ID to it to build an atomic transaction. Note that vendor ID is not required. The vendor's identity is indirectly referred to by productID. Each atomic transaction gets a priority value assigned to it, and is then put into a “to send” queue. The “send process” would compress the message, and insert the transaction into the queue, according to its priority (priorities would be assigned based on the urgency of the transaction, which would be a function of the kind of product being purchased). Transactions that have a higher priority are sent first, and should be allowed to “cut” the line in order to exit the queue faster.

Transaction Dequeuing, Transformation and Submission to Partner

The atomic transaction would be sent to the ground server with the least amount of load within the network (this could be accomplished though a load balancing scheme, using round-robin DNS or some other scheme). Once the server receives the transaction message, a “decoding process” replaces the ID's with their full records' content, and hands the complete information set (what I would call a generic fully realized internet transaction, or GFRIT) off to a “transformation process”. The transformation process would launch a transformation script corresponding to that vendor, and pass it the GFRIT as an argument. The script would execute the transaction through the partner's e-commerce system. It could work by driving the partner's web site and executing the purchase by posting data to the systems' CGIs or similar web active processes.

Database Synchronization/Replication

The ability to synchronize part or all of the data between the GSN and the ADS systems includes the ability to make incremental or single record updates (for updating customer profiles), full table updates, and updates to files in the file hierarchy. Record updating using the low speed in-flight link should only occur when necessary to complete a transaction. Table, Database and file synchronization preferably is not allowed over the low bandwidth in-flight link. A full synchronization of all tables, and files should begin as soon as the high-speed gateway link becomes available. There should also be synchronization between servers in the GSN.

Customer Tracking/Profiling

The ability to keep a record of which parts of the system a customer has visited. The system should also be able to compile statistics on this information, and provide this information though a web interface.

Web Based Administration/Maintenance System

The ability to allow administrators to check on the status of any one of the elements of the system (ADS servers, servers within the GSN, partner's servers which the system interacts with). The system should display any error conditions that may exist, allow command line and GUI base interaction, and the ability to reset or restart the hardware.

Web Caching/Proxying

For those passengers that simply must have direct access to the Internet, the system needs a object caching server to provide rapid access to frequently accessed sites. The proxy/object cache should be capable of linking into an existing object cache hierarchy, or setting up one of its own. Cache nodes would exist on both the ADS and servers in the GSN. Squid is one possibility, MS proxy is another.

While caching multiple pages of a website provides the remote user with the “last view” of a subset of a site, the present invention enables full website, no broken links and dynamic updates during the flight. The re-hosting technology supports real time transactions, and personalized services. Caching systems do not, as they tend to lose dynamic properties such as searching and e-commerce capabilities as well as server-side applications that must interact with a website databases. Caching also requires significantly more storage memory, reducing the number of sites that can be presented to a user. Caching does not meet user expectations for the Internet due to its low quality, static nature and inflexible content.

In operation, the remote user 13 is presented the look and feel of being connected directly to the internet and merchant websites. Via the communication link 22 between the remote server 19 and the central server 16, the central server preferably periodically transmits updated website information from merchant websites to the remote server. Preferably, updating of information is limited to those partners 34 which are partners of the remote internet system 10 of the present invention. By way of example, if a particular partner has added products to be sold through its website, during periodic communication between the central server 16 and the remote server 19, such periodic updates can occur at any random or regular time interval such as hourly, daily, weekly or whenever a partner updates their product information. By limiting the times and scope of information update transmittal, the bandwidth for such transmitted data is minimized. Because smaller remote servers 19 and smaller remote communication systems 28 can therefor be utilized, the remote internet system 10 can be implemented in a more practical and cost effective manner.

Since the remote server 16 has stored therein actual partner website 34 information, and not merely cached or static information, the remote user 13 can dynamically interact with the partner website 34 as if the remote user 13 were connected directly to the internet from his or her land based personal computer. When the remote user 13 has completed the transactions with the partner website 34, the remote server 19 transmits this transaction information to the central server 16. Similarly, the central server 16 transmits this transaction information to the partner website 34 which fulfills transactions executed by the remote user 13. In effect, the remote server 19 acts much like a local internet on the remote location 14, be it a moving vehicle like an airplane or ship or a land-based remote location.

The software and data management system of the present invention is designed to integrate with existing hardware and communications systems on existing aircraft or ships, maximize the effectiveness of these systems and allow users to access their existing e-mail accounts in a cost effective and intuitive manner. For airlines operating a mixed fleet of systems, the present invention integrates seamlessly on any platform. This allows for rapid deployment of services fleetwide and continuity of service as they adopt new hardware systems or equip the aircraft with wideband satellite technology for off-aircraft communications.

While specific embodiments of the invention have been described in detailed, it will be appreciated by those skilled in the art that various modifications and alterations will be developed in light of the over all teachings of the disclosure. Accordingly, the particular invention disclosed are meant to be illustrative only and not limiting as to the scope of the invention which is to be given the full breadth of the appended claims and in any and all equivalents thereof.

We claim:

1. A system for remote users to access a telecommunications network, the system comprising:
a fixed server operably connected to the telecommunications network;
a remote server including connection means for a remote user to access the remote server; and
a communication link for connecting the remote server to the fixed server whereby the remote user is connected to the telecommunications network.

2. The system as recited in claim 1, wherein the communication link comprises a satellite up-link operatively connected between the mobile server and the fixed server.

3. The system as recited in claim 1, wherein the fixed server is operably connected to the telecommunications network to continuously receive information therefrom, and wherein the fixed server periodically transmits such information to the remote server via the communication link.

4. The system as recited in claim 3, wherein the remote user comprises a mobile user and wherein the remote server comprises a mobile server operably connected to a moving vehicle.

5. The system as recited in claim 4, wherein the moving vehicle is an airplane.

6. The system as recited in claim 4, wherein the moving vehicle is a ship.

7. A method of connecting remote internet users with a central telecommunications network, said method comprising the steps of:
providing a remote internet server including means for connecting a remote internet user with the remote internet server;
providing a ground based internet server for connection to the central telecommunications network; and
connecting the mobile internet server with said ground based internet server.

8. The method as recited in claim 7, wherein the step of providing a mobile internet server further comprises:
providing access to a portal site on the mobile internet server;
providing a registration screen for registering the mobile internet user with the portal site; and
receiving profile information from the mobile internet user to register the mobile internet user with the portal site.

9. The method as recited in claim 8, wherein the step of connecting the mobile internet server with said ground base internet server comprises providing a communication link between the portal site and the ground based internet server.

10. An apparatus for conducting internet commerce from a moving vehicle, the apparatus comprising:
a remote web server associated with the moving vehicle;
means for connecting an internet user with the remote web server;
a central web server located in a fixed location;
means for connecting the central web server to a global telecommunications network, such that internet website information is transmitted between the central web server and said global telecommunications network;
a communication link operably connecting the remote web server and the central web server; and
means for periodically transmitting internet information between said central web server and said remote web server whereby the internet user can conduct internet commerce with the remote web server.
